(19) United States
(12) Patent Application Publication
(10) Pub. No.: US 2025/0204620 A1
(43) Pub. Date: Jun. 26, 2025

(54) HEATED ARTICLE OF CLOTHING WITH CONTROL BUTTON WIRE ROUTING

(71) Applicant: MILWAUKEE ELECTRIC TOOL CORPORATION, Brookfield, WI (US)

(72) Inventors: Bradley Van Wagoner, Germantown, WI (US); Todd R. Mader, Grafton, WI (US); Stacy Rogers, Racine, WI (US); Laura Foley, New Berlin, WI (US); Matthew D. Strommen, Greendale, WI (US)

(21) Appl. No.: 18/983,635

(22) Filed: Dec. 17, 2024

Related U.S. Application Data
(60) Provisional application No. 63/613,101, filed on Dec. 21, 2023.

(51) Int. Cl. A41D 13/005; H05B 3/00; H05B 3/34

(52) U.S. Cl. CPC A41D 13/0051; H05B 3/0019; H05B 3/342; A41D 2400/12

(57) ABSTRACT

An article of clothing including a torso body having a front and a rear, a heating array coupled to the torso body, a battery receptacle configured to receive a battery pack and supply electrical energy to the heating array, a control button assembly positioned on an upper corner of the torso body, and a cable extending from the control button assembly away from the front of the torso body to connect the control button assembly to the heating array.

### CROSS-REFERENCE TO RELATED APPLICATIONS

The present application claims priority to U.S. Provisional Application No. 63/613,101, filed Dec. 21, 2023, the entire contents of which are incorporated by reference herein.

### BACKGROUND OF THE INVENTION

The present disclosure generally relates to heated gear and, more particularly, to a heated article of clothing with an electronic control button.

### SUMMARY

In some implementations, the disclosure provides an article of clothing including a torso body having a front and a rear, a heating array coupled to the torso body, a battery receptacle configured to receive a battery pack and supply electrical energy to the heating array, a control button assembly positioned on an upper corner of the torso body, and a cable extending from the control button assembly away from the front of the torso body to connect the control button assembly to the heating array.

In some implementations, the disclosure provides an article of clothing including a torso body having a front and a rear, a heating array coupled to the torso body, a battery receptacle configured to receive a battery pack and supply electrical energy to the heating array, a control button assembly positioned on the front of the torso body, and a cable extending at an oblique angle from a corner of the control button assembly along a side of the torso body to connect the control button assembly to the heating array.

In some implementations, the disclosure provides an article of clothing including a torso body having a front and a rear, a heating array coupled to the torso body, a battery receptacle configured to receive a battery pack and supply electrical energy to the heating array, a control button assembly positioned on the front of the torso body, and a cable extending from a top of the control button assembly and over a shoulder of the torso body to connect the control button assembly to the heating array.

Other independent aspects of the disclosure will become apparent by consideration of the detailed description, claims, and accompanying drawings.

### BRIEF DESCRIPTION OF THE DRAWINGS

FIG. 1 is a front perspective view of a jacket.

FIG. 2 is a back view of the jacket shown in FIG. 1.

FIG. 3 is an electrical block diagram for the jacket shown in FIG. 1

FIG. 4 is a schematic diagram of the jacket shown in FIG. 1.

FIG. 5 is an isolated view of a control button assembly of the jacket shown in FIG. 1.

FIG. 6 is a front view of a first implementation of a control button assembly of the jacket shown in FIG. 1.

FIG. 7 is an isolated front view of a control board of the jacket shown in FIG. 1.

FIG. 8 is a front view of a first implementation of a control board of the jacket shown in FIG. 1.

FIG. 9 is a front view of a second implementation of a control board of the jacket shown in FIG. 1.

FIG. 10 is an isolated view of a second implementation of a control button assembly of the jacket shown in FIG. 1.

FIG. 11 is a front view of the control button assembly shown in FIG. 10.

FIG. 12 is a side view of the control button assembly shown in FIG. 10.

FIG. 13 is a back view of the control button assembly shown in FIG. 10.

FIG. 14 is another front view of the control button assembly shown in FIG. 10.

FIG. 15 is another side view of the control button assembly shown in FIG. 10.

FIG. 16 is another back view of the control button assembly shown in FIG. 10.

FIG. 17 is a front view of a third implementation of a control button assembly of the jacket shown in FIG. 1.

### DETAILED DESCRIPTION

Before any independent implementations of the disclosure are explained in detail, it is to be understood that the disclosure is not limited in its application to the details of construction and the arrangement of components set forth in the following description or illustrated in the following drawings. The disclosure is capable of other independent implementations and of being practiced or of being carried out in various ways. Also, it is to be understood that the phraseology and terminology used herein is for the purpose of description and should not be regarded as limiting.

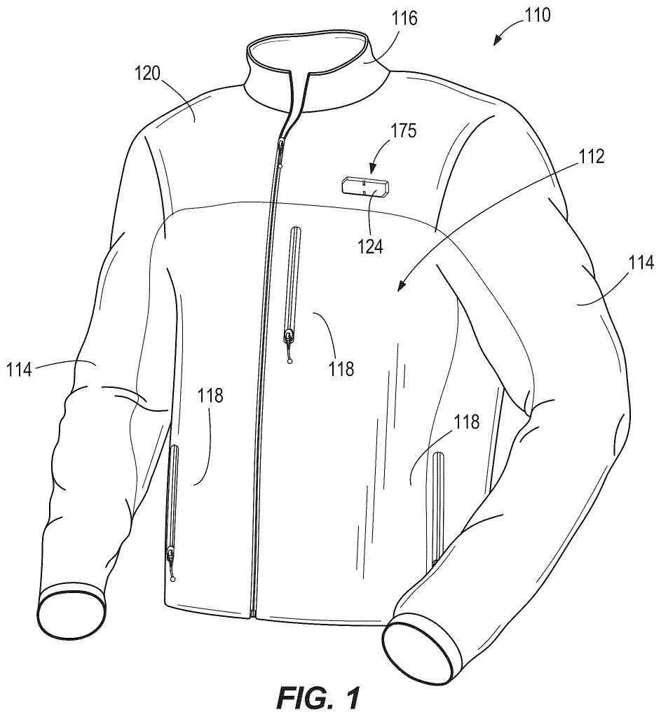

FIG. 1 illustrates an article of clothing, such as a jacket 110, including an electrical component to be controlled. In the illustrated construction, the jacket 110 is a heated jacket similar to that described and illustrated in U.S. Patent Application Publication No. US2011/0108538A1, published May 12, 2011, and in U.S. Patent Application Publication No. US2013/0037531A1, published Feb. 14, 2013, the entire contents of both of which are hereby incorporated by reference. In other constructions (not shown), the jacket 110 may include, in addition to or as an alternative to a heating component, another component to be controlled, such as, for example, a component for cooling, illumination, communication, power supply, combinations thereof, etc.

The jacket 110 may be constructed in various sizes to fit a variety of users. The jacket 110 may include at least a torso body 112. The torso body 112 may define a front and a rear of the jacket 110. The jacket 110 may also include other typical jacket components such as arms 114, a collar 116, and front pockets 118. In other constructions (not shown), the article of clothing may have another configuration (e.g., overalls, a vest, a hooded garment, or any other type of article or gear that is worn on the torso).

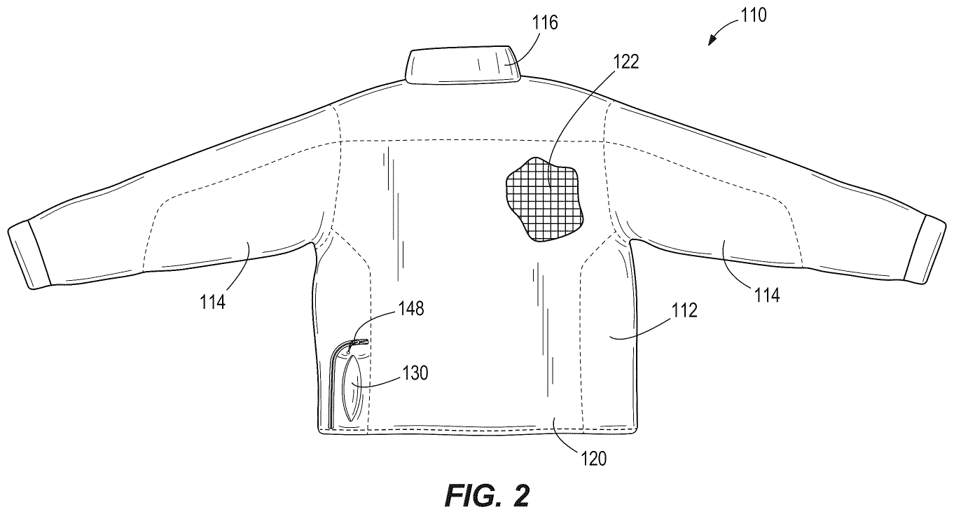

The jacket 110 may also include an outer shell 120 and an inner shell 122 (FIG. 2). In the illustrated implementation, the outer shell 120 may be made from a polyester material and is constructed to protect the user from wind, rain, and other weather elements. In some implementations, the outer shell 120 has an outer surface that is exposed to the elements and that may be waterproof, windproof, or a combination thereof. The inner shell 122 provides an inner lining for the jacket 110 for additional warmth and comfort. In some implementations, the inner shell 122 lines the inside of the jacket including the torso body 112, the arms 114, the collar 116, and the pockets 118. In other implementations, the inner shell 122 lines only select areas of the jacket 110. For example, in some implementations, the inner shell 122 lines the torso body 112, but not the arms 114. The inner shell 122 may be coupled to the outer shell 120 by sewing along at least the borders of the jacket 110.

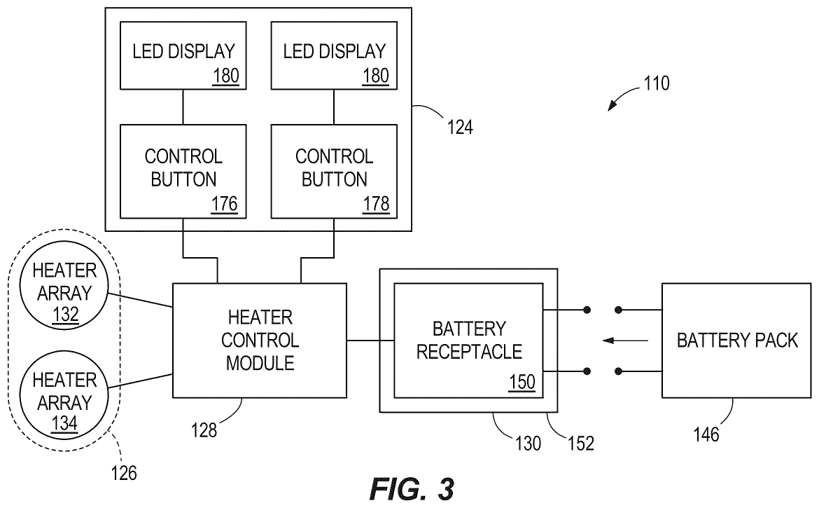

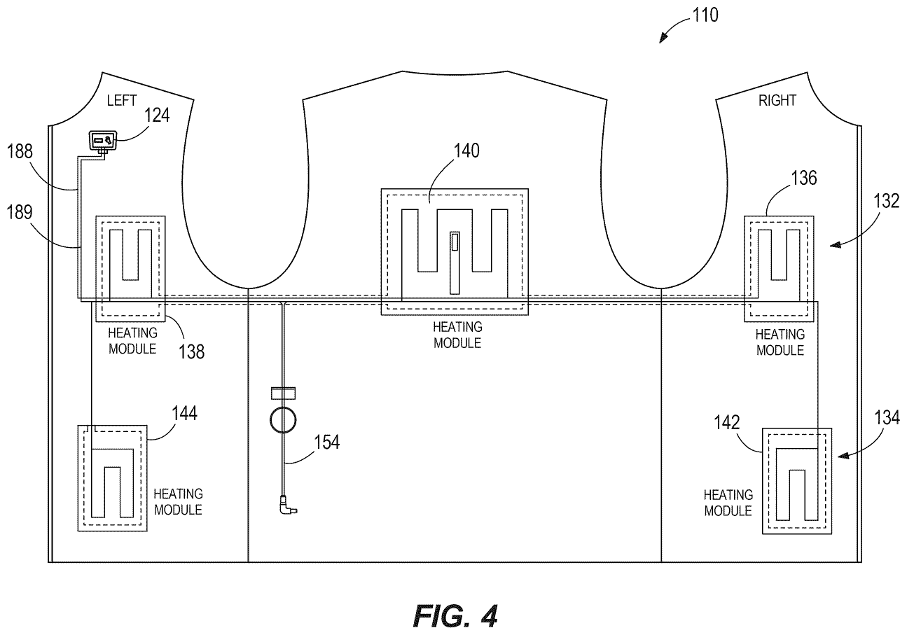

As shown in FIG. 3, the illustrated jacket 110 also includes a control button assembly 124, a heating array 126, a heater control module 128, and a battery compartment 130 (FIGS. 2 and 3). The heating array 126 may include any suitable arrangement of one or more heaters. For example, the heating array 126 may include a core heating array 132. The heating array 126 may additionally or alternatively include a pocket heating array 134. As shown in FIG. 4, the core heating array 132 may include a right chest heating module 136, a left chest heating module 138, and a back heating module 140. The pocket heating array 134 may include a right pocket heating module 142 and/or a left pocket heating module 144. The heating arrays 132, 134 may include resistive heating coils formed of carbon fibers, high-density carbon fibers, or other heating devices.

The core heating array 132 and pocket heating array 134 are controlled via the heater control module 128 and the control button assembly 124. The user interacts with the control button assembly 124 to control operation of the heating array 126. The heating array 126 receives electrical energy from a battery pack 146 (FIG. 3) received in the battery compartment 130 and converts said electrical energy into heat. In other implementations, the heating array 126 can include more or less heater modules and/or the heater modules may be positioned elsewhere throughout the jacket 110. In some implementations, the jacket 110 includes a single heater module in the torso body 112 instead of multiple heater modules.

As shown in FIG. 2, the battery compartment 130 is located on a lower portion of the back torso body. In other implementations, the battery compartment 130 may be located elsewhere on the jacket 110. The battery compartment 130 includes a zipper 148, providing selective access by a user to the battery compartment 130 in order to access the battery pack 146 and other electrical components. The battery compartment 130 includes a battery receptacle 150 (FIG. 3) configured to receive the battery pack 146.

The battery receptacle 150 may include a USB type port 152 for communicating with and charging other electronic devices, such as a digital media player, an iPod®, a smartphone, or another similar device. The battery receptacle 150 receives electrical energy from the battery pack 146 and supplies the electrical energy to the heater control module 128 for distribution to the heating arrays 132, 134. The battery receptacle 150 transmits the electrical energy through a heater supply cable 154 (FIG. 4). The heater supply cable 154 is detachably coupled to the battery receptacle 150 on a first end. In some implementations, the battery receptacle 150 may also include a battery state-of-charge indicator including, for example, one or more LEDs.

In the illustrated implementation, the battery receptacle 150 is configured to receive the battery pack 146. The battery pack 146 may be a 12-volt lithium-based battery pack and may also be operable to power other devices, such as a power tool (not shown; e.g., a drill, a pipe cutter, an impact driver, a saw, etc.), a non-motorized device (not shown; e.g., a sensing device (a camera, a sensor, a multi-meter, a scanner, etc.)), etc. having a similarly-configured receptacle as the battery receptacle 150.

In other implementations, the battery receptacle 150 may have a different construction to accommodate different types of battery packs (e.g., having a different voltage, chemistry, interface, etc.). For example, in some implementations (not shown), the battery receptacle 150 may receive an 18-volt battery pack or another type of battery pack.

Referring back to FIG. 3, the heater control module 128 receives inputs from the control button assembly 124 and selectively powers the heating arrays 132, 134. The heater control module 128 is coupled to a chest portion 175 of the jacket 110 (FIG. 1). For example, the heater control module 128 may be part of or located within the control button assembly 124. Alternatively, the heater control module 128 may be separate from the control button assembly 124. In other implementations, the heater control module 128 may be located elsewhere on the jacket 110. The heater control module 128 may be configured to monitor a plurality of conditions of the jacket 110 including, but not limited to, an amount of current drawn by the heating arrays 132, 134.

The heater control module 128 includes, for example, a microprocessor, microcontroller, etc., and is configured to communicate with a controller of the battery pack 146. In the illustrated implementation, the battery controller provides information to the heater control module 128 related to a battery pack temperature and/or voltage level. The heater control module 128 and the battery controller may also include low voltage monitors and state-of-charge monitors. The monitors are used to determine whether the battery pack 146 is experiencing a low voltage condition, which may prevent proper operation of the heating arrays 132, 134 or if the battery pack 146 is in a state-of-charge that makes the battery pack 146 susceptible to being damaged. If such a low voltage condition or state-of-charge exists, the heating arrays 132, 134 are shut down or the battery pack 146 is otherwise prevented from further discharging current to prevent the battery pack from becoming further depleted and/or damaged.

The heater control module 128 receives a user input from the control button assembly 124 that specifies whether the heating arrays 132, 134 are activated and may, in some implementations, specify particular heating modules to be activated. For example, the control button assembly 124 may be activated to turn the heating array 132, 134 on to automatically set to an initial predetermined thermal output setting. If the control button assembly 124 is already activated (e.g., pressed), the control button assembly 124 changes the operation of the heating modules 136-144. For example, the control button assembly 124 may be used for the jacket 110 to switch between a high setting, a medium setting, and low setting. The heating modules 136-144 provide a high, medium, and low thermal output, respectively. In some implementations, when the control button assembly 124 is first activated, the jacket 110 enters a pre-heat mode. The jacket 110 may remain in the pre-heat mode for a predetermined period of time before the heater control module 128 switches the heating modules 136-144 to the medium setting. The user may at any point adjust the thermal output setting with the control button assembly 124.

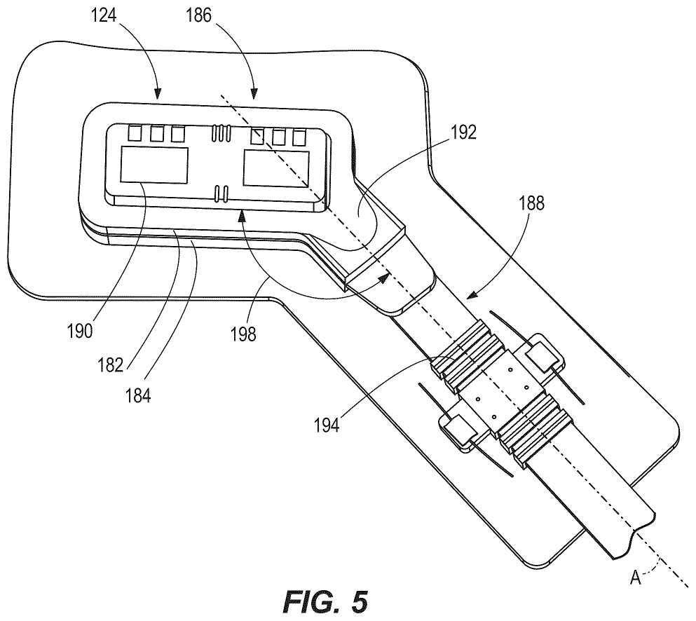

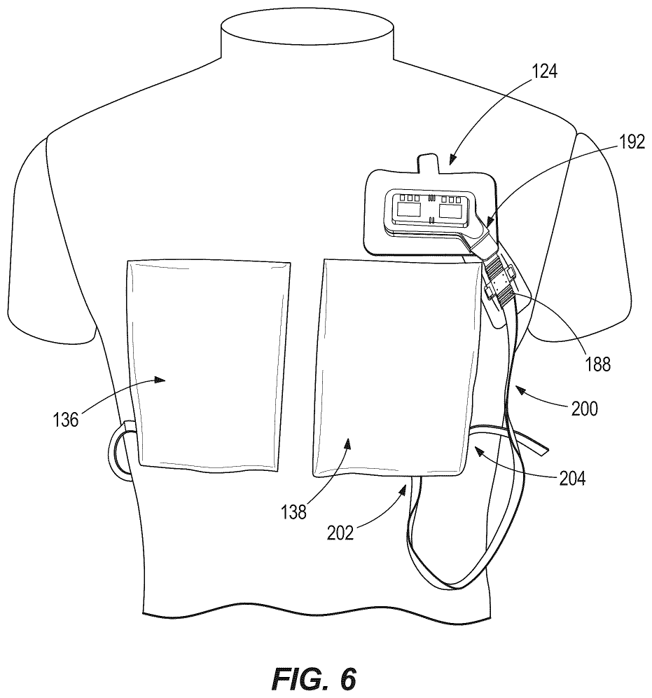

Referring back to FIG. 1, the illustrated control button assembly 124 is located on the front of the jacket 110. The control button assembly 124 may also be referred to as a user interface. The control button assembly 124 is positioned on an upper corner of the jacket 110 to provide ease of access to the user. The illustrated control button assembly 124 is positioned on an upper left corner of the jacket 110. In other implementations, the control button assembly 124 may be located elsewhere on the jacket 110, such as the upper right corner of the jacket 110. As shown in FIGS. 5 and 6, the control button assembly 124 includes an interface 186, a display portion 180 (FIG. 3), and protective layers 182, 184. The control button assembly 124 is coupled to the heater control module 128 to provide the heater control module 128 with user input information to control the heating arrays 132, 134.

The illustrated interface 186 may include a first heater control button 176 and a second heater control button 178 (FIG. 3). In the illustrated implementation, the first and second heater control buttons 176, 178 are push buttons for ease of use. In other implementations, the heater control buttons 176, 178 may include other types of actuators, such as capacitive sensors, rotary dials, slider switches, and the like. In the illustrated implementation, the first heater control button 176 is an on/off button for the heating modules 136-144. In the illustrated implementation, the heating modules 136-144 turn on after the on/off button 176 is pressed and held for a designated period of time (e.g., 1.5 seconds).

Once activated the heating arrays 136-144 may, in some implementations, be automatically set to an initial predetermined thermal output setting. In the illustrated implementation, subsequent presses of the on/off button 176 change the thermal output setting according to a sequence (e.g., high, medium, low then back to high and so on). The on/off button 176 is configured to turn the heating modules 136-144 off after being pressed and held for designated period of time (e.g., 1.5 seconds). In other implementations, the number of thermal output settings, the initial thermal output setting, and the sequence of thermal output settings could vary.

In the illustrated implementation, the second heater control button 178 is a zone button to determine which heating modules 136-144 are activated. The zone button 178 controls whether the core heating array 132, the pocket heating array 134, or both heating arrays 132, 134 are turned on/off. In other implementations, the control button assembly 124 may include more than one zone button 178. For example, the control button assembly 124 may include a zone button 178 for each heating module 136-144 to provide more localized heating control.

As illustrated in FIG. 4, a cable 188 extends from the control button assembly 124 to connect the control button assembly 124 to the heating array(s) 132, 134. The cable 188 includes one or more cables. The cable 188 includes at least one electrically conductive wire 189 electrically connected to a circuit board 190 (FIG. 9) disposed in the control button assembly 124. The cable 188 may include a plurality of circuit board wires 189, and the wires 189 may be sheathed in an insulative material individually and collectively. In some implementations, the insulative material containing the collective plurality of wires 189 may be referred to as a sheath 194. The sheath 194 is configured to contain the wires 189 and reduce disorganization and tangling of the wires 189. In FIG. 4, the cable 188 extends from a bottom of the control button assembly 124. However, as described below, the cable 188 may extend from the circuit board 190 in other directions.

FIGS. 5-9 illustrate an implementation of the control button assembly 124 in which the cable 188 extends from a corner 192 of the circuit board 190 (and therefore of the control button assembly 124) to connect the control button assembly 124 to the heating array(s) 132, 134. The corner 192 is defined at an intersection between a long edge and a short edge of the circuit board 190. In the illustrated implementation, the cable 188 extends from a bottom, outboard corner of the circuit board 190 (e.g., the bottom right corner as viewed in FIG. 5). In another implementation, the cable 188 may extend from an upper, outboard corner of the circuit board 190 (e.g., the upper right corner as viewed in FIG. 5). In the present implementation, the cable 188 includes the plurality of circuit board wires 189. The wires 189 are contained within the sheath 194 to facilitate routing of the cable 188 within the jacket 110. In other words, the sheath 194 keeps the wires 189 within the cable 188 together and reduces the possibility of the wires 189 from being separated or tangled while the cable 188 is routed throughout the jacket 110.

The cable 188 extends from the corner 192 of the circuit board 190 along an axis A. The axis A is obliquely angled relative to an edge (e.g., a bottom edge) of the circuit board 190 (and therefore of the control button assembly 124). For example, the axis A may be oriented at an angle 198 relative to the edge of the circuit board 190. In the illustrated implementation, the angle 198 is measured between the axis A and the long edge of the circuit board 190. In other implementations, the angle 198 may be measured between the axis A and the short edge of the circuit board 190. The illustrated angle 198 is an oblique angle. The angle 198 is greater than 90 degrees and less than 180 degrees. For example, the angle 198 may be about 135 degrees. In other implementations, the angle may be between 120 and 150 degrees. In still other implementations, the angle 198 may be any angle between 0 degrees and 360 degrees.

As shown in FIG. 6, the cable 188 extends at the angle 198 from the circuit board 190 (and therefore the control button assembly 124) such that the cable 188 is directed away from the control button assembly 124 along a side 200 of the torso body 112. The illustrated cable 188 then wraps around the front of the torso body 112 to connect with a bottom 202 of the left chest heating module 138. The cable 188 also extends from a left side 204 of the left chest heating module 138 to connect the control button assembly 124 with the remaining heating array(s) 132, 134. For example, the cable 188 may extend from the left chest heating module 138, around the rear of the torso body 112, to the right chest heating module 136. Alternatively, the cable 188 may extend from the left chest heating module 138 and around a left side of the torso body 112 to the back heating module 140. The cable 188 may then extend from the back heating module 140 and around a right side of the torso body 112 to the right chest heating module 136. In some implementations, the cable 188 may be routed in other manners after extending from the corner 192 of the circuit board 190. For example, the cable 188 may be extend from the circuit board 190 to the left side 204 of the left chest heating module 138. Additionally, the left chest heating module 138 may be connected to the other heating array(s) 132, 134 in other manners. Directing the cable 188 from the control button assembly 124 along the side 200 of the torso body 112, rather than directly down a front the torso body 112, allows for greater comfort for some users, particularly female users.

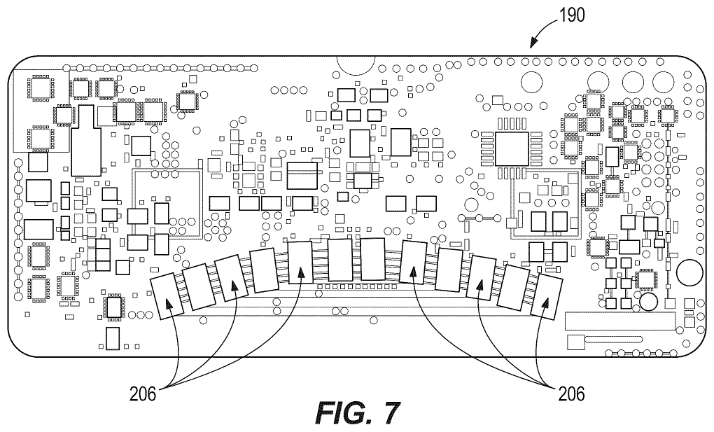

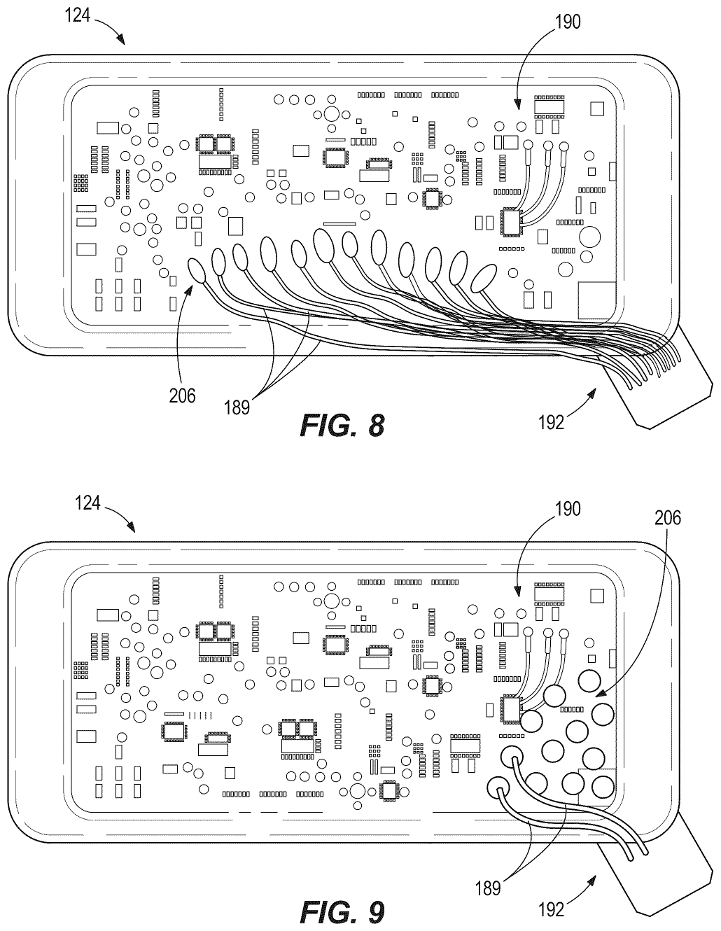

Referring to FIGS. 7-9, the wires 189 of the cable 188 may be connected to the circuit board 190 in a plurality of ways. Each wire 189 has a wire connection point 206 with the circuit board 190, enabling connection between the control button assembly 124 and the heating array(s) 132, 134. FIGS. 7 and 8 illustrate one implementation in which the wires 189 are connected with the circuit board 190 in a fan configuration. In the fan configuration, the wire connection points 206 form an arc shape extending along a bottom end of the circuit board 190. The wires 189 extending from the wire connection points 206 in the fan configuration further extend toward the corner 192 of the circuit board 190 to enable the implementation of FIGS. 5 and 6. Alternatively, the wires 189 may be routed to any side of the circuit board 190.

FIG. 9 illustrates a second implementation in which the wires 189 are connected with the circuit board 190 in a corner grouped configuration. In this implementation, the wire connection points 206 are grouped near the corner 192 and staggered. Including the wire connection points 206 near the corner 192 allows for simplification of containment of the wires 189 to extend the cable from the corner 192 of the circuit board 190. The corner grouped configuration further frees up board space and allows for varying wire length.

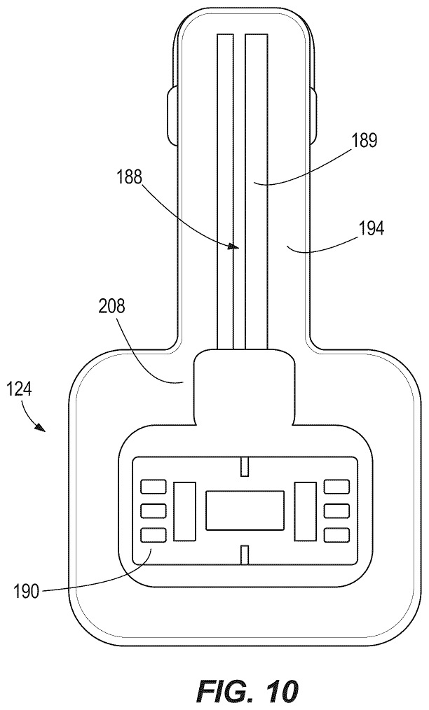

FIGS. 10-16 illustrate a second implementation of the control button assembly 124 in which the cable 188 extends from a top 208, or upper edge, of the circuit board 190 (and therefore of the control button assembly 124) to connect the control button assembly 124 to the heating array(s) 132, 134. In the present implementation, the cable 188 includes the plurality of circuit board wires 189 and the wires 189 are contained within the sheath 194 to facilitate routing of the cable 188 within the jacket 110. In other words, the sheath 194 keeps the wires 189 within the cable 188 together and reduces the possibility of the wires 189 from being separated or tangled while the cable 188 is routed throughout the jacket 110. In alternate implementations, a sheath may not be used to contain the wires 189.

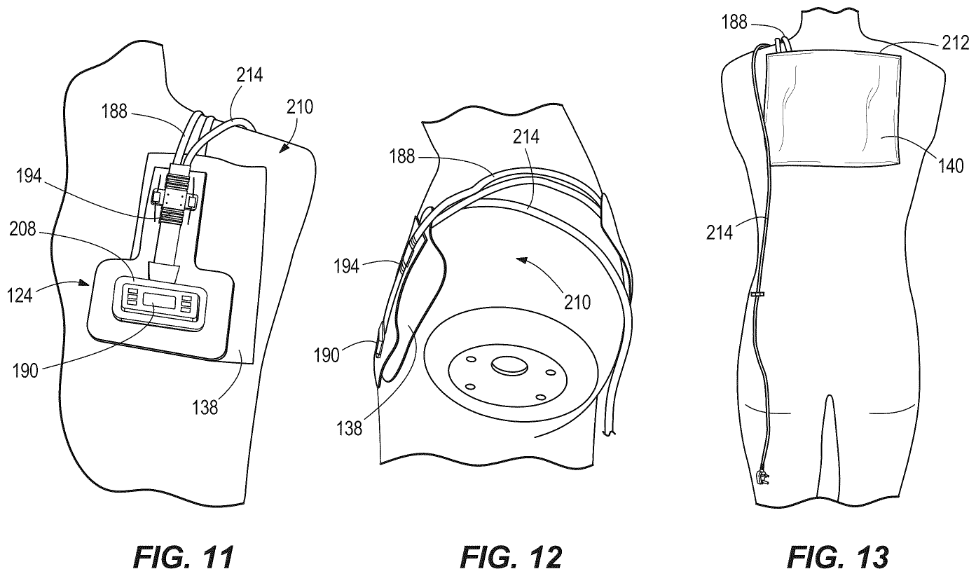

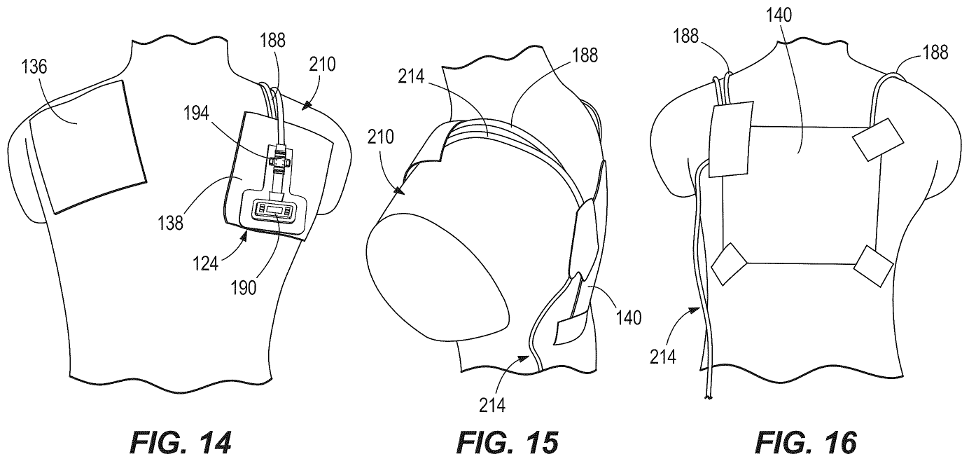

As shown in FIGS. 11 and 12, the cable 188 extends from the top 208 of the circuit board 190 (and therefore the control button assembly 124) such that the cable 188 is directed over a shoulder 210 of the jacket 110. The illustrated cable 188 then connects with the back heating module 140, as shown in FIG. 13. After connecting with the back heating module 140, the cable 188 further extends from a top 212 of the back heating module 140 and over the shoulder 210 to connect with the left chest heating module 138, as shown in FIG. 12. After connecting the cable 188 with the left chest heating module 138, the cable 188 is further routed throughout the jacket 110 to connect the control button assembly 124 with the remaining heating array(s) 132, 134. For example, as shown in FIGS. 14-16, the cable 188 is also routed from the back heating module 140 to the right chest heating module 136. In this example, the cable 188 is directed over the other shoulder of the jacket 110, opposite from the control button assembly 124. In some implementations, the cable 188 may be routed in other manners after extending from the top 208 of the circuit board 190. For example, the cable 188 may be routed from the top 208 of the circuit board 190, over the shoulder to the back heating module 140, and then across a user's side(s) to the left and/or right chest heating modules 138. Directing the cable 188 over the shoulder 210 of the jacket 110 allows for greater comfort for the user by directing the cable 188 away from the front of the user's body.

In the illustrated implementation, a power cord 214 also extends from the top 208 of the circuit board 190 (and therefore the control button assembly 124) such that the power cord 214 is directed over the shoulder 210 of the jacket 110 to connect with the back heating module 140. The power cord 214 further extends from a side of the back heating module 140 and down the jacket 110 to connect with the battery receptacle 150 and the battery pack 146. In other embodiments, the power cord 214 may be routed through the jacket 110 in other manners.

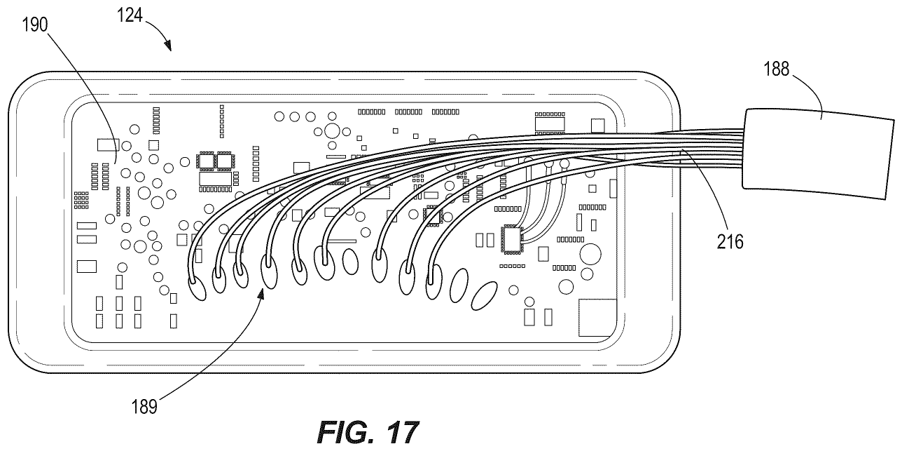

FIG. 17 illustrates a third implementation of the control button assembly 124 in which the cable 188 extends from a right side 216 of the circuit board 190 to connect the control button assembly 124 to the heating array(s) 132, 134. In the present implementation, the wires 189 extend from and are connected to the circuit board 190 in a fan configuration (e.g., as shown in FIGS. 7 and 8). In the present implementation, the wires 189 may be contained within the sheath 194 to facilitate routing of the cable 188 within the jacket 110.

The cable 188 may extend from the right side 216 of the circuit board 190 (and therefore the control button assembly 124) such that the cable 188 is directed along the side 200 of the torso body 112 and wraps around the front of the torso body 112 to connect the cable 188 with the bottom 202 of the left chest heating module 138. The cable 188 may further extend from the left side 204 of the left chest heating module 138 to connect the control button assembly 124 with the remaining heating array(s) 132, 134.

Alternatively or additionally, the cable 188 may extend from the right side 216 of the circuit board 190 such that the cable 188 wraps around the side 200 of the torso body 112 and the cable 188 connects with the back heating module 140. After connecting with the back heating module 140, the cable 188 may further extend from a top 212 of the back heating module 140 and over the shoulder 210 to connect with the left chest heating module 138. After connecting the cable 188 with the left chest heating module 138, the cable 188 may be further routed throughout the jacket 110 to connect the control button assembly 124 with the remaining heating array(s) 132, 134.

Thus, the disclosure may provide, among other things, an article of clothing, such as a jacket, with a control button assembly having wires 189 routed out a corner, lateral side, or top (superior) thereof.

What is claimed is:

1. An article of clothing comprising:
a torso body having a front and a rear;
a heating array coupled to the torso body;
a battery receptacle configured to receive a battery pack and supply electrical energy to the heating array;
a control button assembly positioned on an upper corner of the torso body; and
a cable extending from the control button assembly away from the front of the torso body to connect the control button assembly to the heating array.

2. The article of clothing of claim 1, wherein the cable extends from a corner of the control button assembly.

3. The article of clothing of claim 2, wherein the cable extends at an oblique angle relative to a bottom edge of the control button assembly.

4. The article of clothing of claim 1, wherein the cable extends from an upper edge of the control button assembly.

5. The article of clothing of claim 1, wherein the heating array includes a front heating module, and wherein the cable extends from the control button assembly along a side of the torso body to the front heating module.

6. The article of clothing of claim 5, wherein the heating array also includes a second heating module, and wherein the cable also extends from the front heating module to the second heating module.

7. The article of clothing of claim 6, wherein the second heating module is another front heating module, and wherein the cable wraps around the rear of the torso body to the another front heating module.

8. The article of clothing of claim 1, wherein the heating array includes a back heating module, and wherein the cable extends from the control button assembly over a shoulder of the torso body to the back heating module.

9. The article of clothing of claim 8, wherein the heating array also includes a second heating module, and wherein the cable also extends from the back heating module to the second heating module.

10. The article of clothing of claim 9, wherein the second heating module is a front heating module.

11. The article of clothing of claim 10, wherein the front heating module is a left chest heating module, wherein the heating array also includes a right chest heating module, and wherein the cable also extends from the back heating module to the right chest heating module.

12. The article of clothing of claim 1, further comprising a power cord extending from the control button assembly to the battery receptacle.

13. The article of clothing of claim 12, wherein the power cord extends away from the front of the torso body.

14. The article of clothing of claim 13, wherein the power cord is directed over a shoulder of the torso body.

15. The article of clothing of claim 1, wherein the control button assembly includes a circuit board, and wherein the cable includes wires connected with the circuit board in a fan configuration.

16. The article of clothing of claim 1, wherein the control button assembly includes a circuit board, and wherein the cable includes wires connected with the circuit board in a corner grouped configuration.

17. An article of clothing comprising:
a torso body having a front and a rear;
a heating array coupled to the torso body;
a battery receptacle configured to receive a battery pack and supply electrical energy to the heating array;
a control button assembly positioned on the front of the torso body; and
a cable extending at an oblique angle from a corner of the control button assembly along a side of the torso body to connect the control button assembly to the heating array.

18. The article of clothing of claim 17, wherein the heating array includes a first heating module located on the front of the torso body and a second heating module, wherein the cable extends from the control button assembly to the first heating module, and wherein the cable extends from the first heating module along the rear of the torso body to a second heating module

19. An article of clothing comprising:
a torso body having a front and a rear;
a heating array coupled to the torso body;
a battery receptacle configured to receive a battery pack and supply electrical energy to the heating array;
a control button assembly positioned on the front of the torso body; and
a cable extending from a top of the control button assembly and over a shoulder of the torso body to connect the control button assembly to the heating array.

20. The article of clothing of claim 19, wherein the heating array includes a rear heating module and a front heating module, wherein the cable extends from the control button assembly to the rear heating module, and wherein the cable extends from the rear heating module to the front heating module.
